(19) United States
(12) Patent Application Publication
(10) Pub. No.: US 2008/0143968 A1
(43) Pub. Date: Jun. 19, 2008

(54) COLOR WHEEL WITH SIX SEGMENTS

(76) Inventor: Wei-Chih Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/693,728

(22) Filed: Mar. 30, 2007

(30) Foreign Application Priority Data
Dec. 13, 2006 (TW) 095146652

(51) Int. Cl. G03B 21/28

(52) U.S. Cl. 353/29; 353/84

(57) ABSTRACT

Disclosed is a six-segment color wheel having a coating thereof and including six color sections, which correspond to different colors respectively including a cyan color section. The spoke white generated from the color wheel comprises the spoke white generated by mixing cyan, and a white color with a predetermined color temperature can be obtained via adjusting coating spectrum on the color wheel and the angle of the color sections.

### BACKGROUND OF THE INVENTION

1. Field of the Invention

The present invention relates to a color wheel, and particularly relates to a color wheel having six color sections with a cyan section.

2. Description of the Prior Art

Since related techniques have been highly developed in recent years, projectors are not only utilized in meetings or conferences, but are also utilized by average families. In particular, the demand for large size flat panel displays has increased substantially in recent years with the consumer expecting high quality display. Therefore, related techniques have improved correspondingly. The projector projects an image to a screen by optical projection, and amplifies the image utilizing an optical method, such that the limitation of a flat panel display is surmounted and the height and weight of the machine is decreased. There are four kinds of major projection techniques: CRT (cathode ray tube), LCD (liquid crystal display), DLP (digital light processing), LCOS (liquid crystal on silicon). The DLP projector is a projector utilizing special light source modulation, which is a new development by Texas Instruments (TI). The major characteristic of such a projector is that it is a full digital reflection projector in itself, having high quality projected images and less volume and weight.

Please refer to FIG. 1. FIG. 1 is a schematic diagram illustrating a prior art DLP projector. The DLP projector shown in FIG. 1 comprises a light source 101, a color wheel 103, a DMD (Digital Micromirror Display) chip 105, a first condensing lens 107, a second condensing lens 109, and a projecting lens 111. The light from the light source 101 passes through the color wheel 103 after being focused by the first condensing lens 107, and is then transmitted to the DMD chip 105 after passing through the second condensing lens 109. Each pixel memory on the DMD chip 105 records the digital signal value of the pixel and transmits the digital signal to a driving electrode, thereby controlling the angular deflection of a micro reflection mirror and deflection time, and projects light to a screen 113 via the projecting lens 111. Since human eyes will maintain what they seem for a short time, the color of the color sections on a color wheel can be mixed to show different colors by adjusting the rotation of the color wheel 103 and the color distribution thereof.

An original color wheel has three segments (RGB), and an improved color wheel has four segments (RGBW). Also, a recently invented color wheel has five segments. Normally, the color wheel of the projector has better color performance if it has more segments, but it also requires a more complicated design. In this embodiment, a five-segment color wheel is taken as an example for the color wheel 103. Please refer to FIG. 2. FIG. 2 is a color wheel 103 with five segments. The color wheel 103 includes a red color section 201, a yellow color section 203, a green color section 205, a white color section 207 and a blue color section 209. The area ratio of the five color sections on the color wheel determines the color performance of the projector. For example, the projector has higher luminance if the white color section 207 has a larger area. The coating spectrum on the color wheel 103 also determines the color gamut of the projector, which also affects the color performance of the projector. Additionally, the color angle distribution of the color wheel 103 determines the luminance efficiency of the projector. The white color (that is, a color gas gray level of 255) generated from such a kind of color wheel has a low color temperature, however, and has less luminance compared with the white color generated from the LCD projector. Because white color of a high color temperature tends towards blue, it appears to be brighter.

Therefore, a new invention is needed to solve the above-mentioned problems.

### SUMMARY OF THE INVENTION

One objective of the present invention is to provide a color wheel, which includes six color sections including a cyan color section and generates a white color of a higher color temperature by mixing cyan color.

One embodiment of the present invention discloses a six-segment color wheel, comprising a coating and six color sections corresponding to different colors respectively and including a cyan color section. A spoke white color generated from the color wheel comprises the spoke white color generated by mixing with cyan, where a white color with a predetermined color temperature can be obtained via adjusting the coating spectrum on the color wheel and the angle of the color sections. The color sections comprise: a red color section, a green color section, a blue color section, a yellow color section, a cyan color section and a white color section.

Another embodiment of the present invention discloses a projecting apparatus, comprising: a light source, for generating light; a first light gathering element, optically coupled to the light source, for focusing the light from the light source; a six-segment color wheel, having six color sections and a coating thereof and optically coupled to the light gathering element; a second light gathering element, optically coupled to the six-segment color wheel; a control chip, optically coupled to the second light gathering element, for receiving and reflecting the light transmitted from the second light gathering element, and for controlling the rotation of the wheel to generate a desired color; and a projecting lens, optically coupled to the control chip, for projecting the light reflected from the control chip to a target object. A spoke white color generated from the color wheel comprises the spoke white color generated by mixing with cyan, where a white color with a predetermined color temperature can be obtained via adjusting the coating spectrum on the color wheel and the angle of the color sections. The color sections comprise: a red color section, a green color section, a blue color section, a yellow color section, a cyan color section and a white color section.

According to the above mentioned color wheel and projecting apparatus, a cyan color can be generated, and a white color having a higher color temperature can be generated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art DLP projector.

FIG. 2 is a color wheel with five segments.

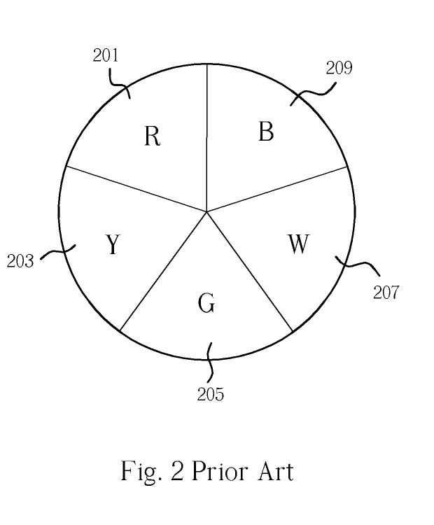

FIG. 3 is a color wheel with six segments according to a first embodiment of the present invention.

FIG. 4 illustrates part of a Blackbody Curve showing the relation between color temperature and color coordinates.

FIG. 5 is a color wheel with six segments according to a second embodiment of the present invention.

### DETAILED DESCRIPTION

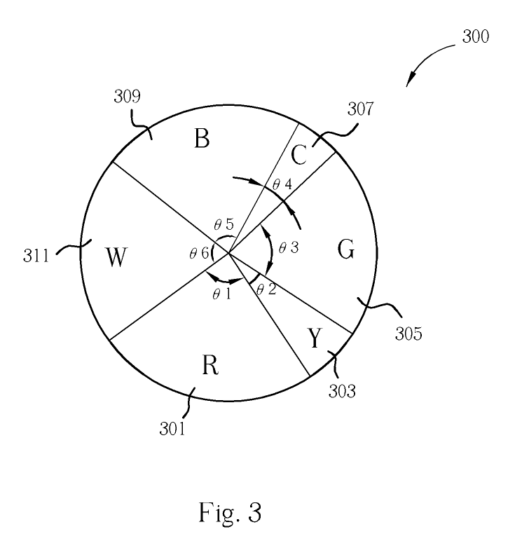

FIG. 3 is a color wheel 300 with six segments according to a first embodiment of the present invention. The color wheel 300 can comprise a red color section 301, a yellow color section 303, a green color section 305, a cyan color section 307, a blue color section 309 and a white color section 311. Since the cyan color is mixed, the white color generated from the color wheel according to the present invention has a higher color temperature than that generated from the above-mentioned five-segment color wheel. Also, a white color with a particular desired color temperature can be obtained by adjusting the ratio and arrangement of the color sections, and the coating spectrum on the color wheel. The angle θ₁ of the red color section is substantially 85°, the angle θ₂ of the green color section is substantially 85°, the angle θ₃ of the blue color section is substantially 74°, the angle θ₄ of the yellow color section is substantially 24°, the angle θ₅ of the cyan color section is substantially 17°, and the angle θ₆ of the white color section is substantially 75°. It should be noted that such an angle distribution is only given as an example to prove that the present invention can generate a white color having a higher color temperature, and is not meant to limit the scope of the present invention. Persons skilled in the art can adjust the ratio of color sections, and the coating spectrum of the color wheel to obtain a desired color. If 50% of the spectrum passes through the yellow color section, the wavelength is approximately equal to 470 nm, and the yellow light tends towards white. Therefore, a preferred method of the present invention is to make a wavelength of the spectrum substantially equal to 473 nm.

Furthermore, CIE utilizes a black body as a standard to define different luminous bodies, which are represented by color temperature (K). The measuring method for a color temperature is that a standard black body is heated to a specific temperate to radiate a specific color of light, wherein the specific temperature is the color temperature of a specific color of light. For example, the color radiated by a luminous body D65 at color temperature 6500 K indicates the color light radiated by a standard black body heated to 6500 K, and the color radiated by a luminous body D70 at color temperature 7000 K indicates the color light radiated by a standard black body heated to 7000 K. As described above, since the color temperature of the white color generated by a five-segment color wheel is low, a user may feel that the brightness is insufficient. The six-segment color wheel according to the present invention wheel has a cyan color section, such that a white color having a higher color temperature can be generated by mixing the white color with cyan. The color temperature of the white color generated by the six-segment color wheel can reach 6200 K, such that the projector using the six-segment color wheel can have a visual effect equal to that of an LCD projector. Detailed data will be given below for proof. Furthermore, since such a color wheel has a cyan color section, the color coordinate x or y of color shift of a pure cyan generated from the six-segment color wheel and a spoke cyan generated from the six-segment color wheel is smaller than 0.01. Additionally, the color gamut can be larger than 58% of NTSC if the coating on a color filter is suitably designed, and the luminous efficiency of the color wheel can reach 60%.

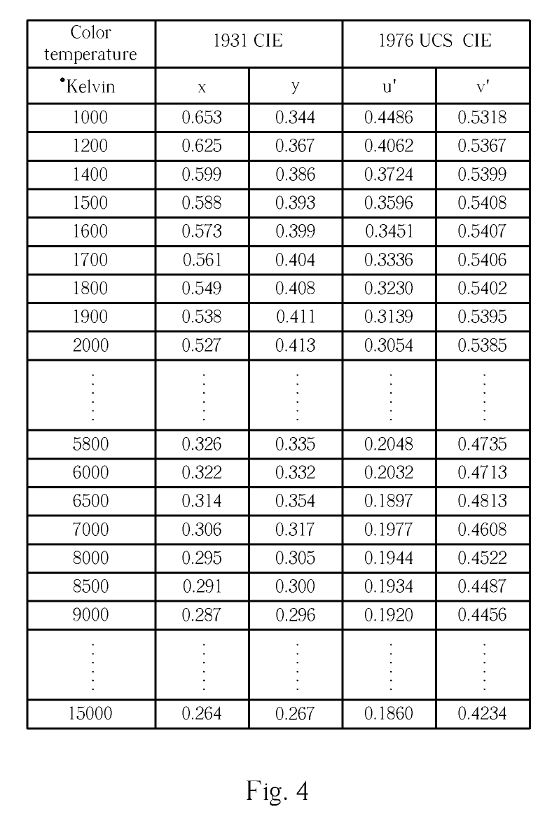

As known by persons skilled in the art, the color temperature is not just indicated by K, but can also be indicated by color coordinates. FIG. 4 illustrates part of the relation between color temperature and color coordinate of the Blackbody Curve. As shown in FIG. 4, different color coordinates correspond to different color temperatures. For example, if a color coordinate (x, y) equals to (0.326, 0.335), it indicates the color temperature equals 5800 K. The white color generated by the above mentioned LCD projector has a color coordinate (0.310, 0.365), which corresponds to a color temperature 6405 K. The white color generated from the color wheel 300 has a color coordinate approximately (0.315, 0.356), which corresponds to color temperature 6235 K. That is, the white color generated from the color wheel 300 according to the present invention has a color temperature the same as an LCD projector. In practice, persons skilled in the art can substitute another color for cyan in order to generate the same white color.

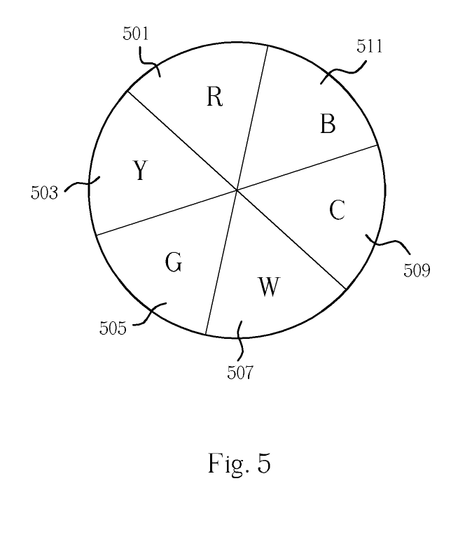

The six-segment color wheel can reach different functions by adjusting other characteristics. For example, the energy of magenta or cyan can reach a predetermined value by adjusting the arrangement of the color sections. The energy of a color indicates the ratio of light passing through a specific color section. As persons skilled in the art will know, the energy of color affects the projector color quality and the color to be displayed. The relation between color energy and color section arrangement is described in FIG. 3 and FIG. 5 and in the following description.

As shown in FIG. 3, the arrangement of the color sections on the color wheel 300 is the red color section 301, the yellow color section 303, the green color section 305, the cyan color section 307, the blue color section 309 and the white color section 311. Such an arrangement can provide cyan with higher energy. It should be noted that such an arrangement is only provided as an example and is not meant to limit the scope of the present invention; persons skilled in the art can utilize the embodiments disclosed in the present invention to realize other arrangements for obtaining the same function, and this also falls within the scope of the present invention.

FIG. 5 is a color wheel with six segments according to a second embodiment of the present invention. As shown in FIG. 5, the arrangement of the color sections on the color wheel is the red color section 501, the yellow color section 503, the green color section 505, the white color section 507, the cyan color section 509 and the blue color section 511. Such an arrangement can obtain a red-purple color with higher energy. Similarly, such an arrangement is only an example and is not meant to limit the scope of the present invention; persons skilled in the art can utilize embodiments disclosed in the present invention to realize other arrangements for obtaining the same function, which also falls within the scope of the present invention.

According to the preferred embodiment shown in FIG. 3, the cyan color section 307 is located between the green color section 305 and the blue color section 309. Since the cyan color is generated by mixing green color and blue color, such a combination can generate a uniform cyan color. It should be noted that the combination of the cyan color section located between the green color section and the blue color section can also be utilized for other arrangements besides the arrangement disclosed in FIG. 3.

The six-segment color wheel according to the present invention can generate specific color via specific design. For example, a prior art color wheel cannot always generate purple color having (R,G,B)=(83, 31, 129) or (100, 61, 142), but the color wheel according to the present invention can generate such a purple color via a specific design. An example method is that the angle of the red color section should be larger than the blue color section by more than 110°, such that the color can be adjusted and mixed to generate the above-mentioned purple.

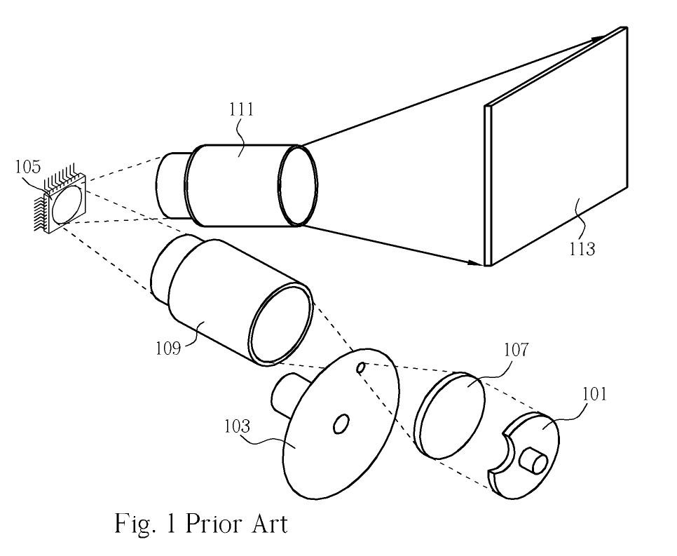

The color wheel according to the present invention can be utilized in the projector shown in FIG. 1, but this is not meant to limit the scope of the present invention. The color wheel according to the present invention can, of course, be utilized in other types of projectors.

According to the above mentioned color wheel, not only a cyan-green color with smaller color shift can be generated, but a white color with a higher color temperature can also be generated. Preferably, other prior art design rules can be utilized for the color wheel to obtain desired results. Therefore, the present invention is a novel invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A six-segment color wheel, comprising a coating and six color sections, which correspond to different colors respectively and include a cyan color section, wherein a spoke white color generated from the color wheel comprises the spoke white color generated by mixing cyan color, where a white color with a predetermined color temperature can be obtained via adjusting a coating spectrum on the color wheel and adjusting the angle of the color sections.

2. The color wheel of claim 1, wherein the color sections comprise:
a red color section;
a green color section;
a blue color section;
a yellow color section;
the cyan color section; and
a white color section.

3. The color wheel of claim 2, wherein the arrangement of the color sections on the color wheel is the red color section, the yellow color section, the green color section, the white color section, the cyan color section and the blue color section.

4. The color wheel of claim 2, wherein the cyan color section is located between the blue color section and the green color section.

5. The color wheel of claim 4, wherein the arrangement of the color sections on the color wheel is the red color section, the yellow color section, the green color section, the cyan color section, the blue color section and the white color section.

6. The color wheel of claim 5, wherein the angle of the red color section is substantially 85°, the angle of the green color section is substantially 85°, the angle of the blue color section is substantially 74°, the angle of the yellow color section is substantially 24°, the angle of the cyan color section is substantially 17°, and the angle of the white color section is substantially 75°.

7. The color wheel of claim 5, wherein the coating of the color wheel makes the color wheel has substantially 60% luminous efficiency.

8. The color wheel of claim 5, having a color gamut substantially larger than 58% NTSC range.

9. The color wheel of claim 5, wherein the coating of the yellow color section passes light with a substantially 473 nm wavelength.

10. The color wheel of claim 5, wherein the color wheel has a color having a gray level of 255 and a substantially 6235 K color temperature.

11. The color wheel of claim 5, wherein the color wheel has a color having a gray level of 255, and color coordinates x and y of the color are substantially (0.315, 0.356).

12. The color wheel of claim 5, wherein the color coordinate x or y of color shift of a pure cyan generated from the color wheel and a spoke cyan generated from the color wheel is smaller than 0.01.

13. The color wheel of claim 5, wherein a purple color generated from the color wheel comprises a purple color with (R, G, B) substantially equal to (83, 31, 129) or (100, 61, 142).

14. The color wheel of claim 5, wherein the angle of the red color section is larger than that of the blue color section by at least 110°.

15. A projecting apparatus, comprising:
a light source, for generating light;
a first light gathering element, optically coupled to the light source, for focusing the light from the light source;
a six-segment color wheel, having six color sections and a coating thereof and optically coupled to the light gathering element;
a second light gathering element, optically coupled to the six-segment color wheel;
a control chip, optically coupled to the second light gathering element, for receiving and reflecting the light transmitted from the second light gathering element, and for controlling the rotation of the color wheel to generate a desired color; and
a projecting lens, optically coupled to the control chip, for projecting the light reflected from the control chip to a target object;
wherein a spoke white color generated from the color wheel comprises the spoke white color generated by mixing cyan color, where a white color with predetermined color temperature can be obtained via adjusting a coating spectrum on the color wheel and the angle of the color sections.

16. The projecting apparatus of claim 15, wherein the color sections comprise:
a red color section;
a green color section;
a blue color section;
a yellow color section;
the cyan color section; and
a white color section.

17. The projecting apparatus of claim 16, wherein the arrangement of the color sections on the color wheel is the red color section, the yellow color section, the green color section, the white color section, the cyan color section and the blue color section.

18. The projecting apparatus of claim 16, wherein the cyan color section is located between the blue color section and the green color section.

19. The projecting apparatus of claim 18, wherein the arrangement of the color sections on the color wheel is the red color section, the yellow color section, the green color section, the cyan color section, the blue color section and the white color section.

20. The projecting apparatus of claim 19, wherein the angle of the red color section is substantially 85°, the angle of the green color section is substantially 85°, the angle of the blue color section is substantially 74°, the angle of the yellow color section is substantially 24°, the angle of the cyan color section is substantially 17°, and the angle of the white color section is substantially 75°.
